(19) United States
(12) Patent Application Publication
(10) Pub. No.: US 2024/0255612 A1
(43) Pub. Date: Aug. 1, 2024

(54) RADAR DEVICE

(71) Applicant: Hitachi Astemo, Ltd., Hitachinaka-shi, Ibaraki (JP)

(72) Inventors: Yukinori AKAMINE, Tokyo (JP); Miyu NAKAO, Tokyo (JP); Hiroshi KURODA, Hitachinaka-shi, Ibaraki (JP); Nobuyuki TAKAYA, Hitachinaka-shi, Ibaraki (JP)

(73) Assignee: Hitachi Astemo, Ltd., Hitachinaka-shi, Ibaraki (JP)

(21) Appl. No.: 18/561,239

(22) PCT Filed: Feb. 2, 2022
(86) PCT No.: PCT/JP2022/003916

§ 371 Date: Nov. 15, 2023

(30) Foreign Application Priority Data
May 17, 2021 (JP) 2021-083172

(51) Int. Cl. G01S 7/40; G01S 13/60

(52) U.S. Cl. CPC G01S 7/403; G01S 13/60

(57) ABSTRACT

When a deviation has occurred in a mounting angle in a radar device, the deviation is automatically detected and automatically corrected in a short time. A lateral wall parallel to a traveling direction is extracted through a function fitting process by a function fitting processing unit (112) from a distance and a relative speed which are a result of performing positioning of a radar device. Then, a calculation processing unit (114) calculates an angle azimuth β of each point extracted as the lateral wall based on a host vehicle speed calculated at the time of the function fitting and the distance to the lateral wall. A comparison processing unit (115) compares the calculated angle azimuth β with an angle azimuth Θ that is a positioning result to detect a mounting angle deviation in the radar device, and a correction processing unit (116) corrects the mounting angle deviation.

### TECHNICAL FIELD

The present invention relates to a radar device, and particularly to a technique related to correction of angle deviation in mounting of an in-vehicle radar device mounting on a vehicle.

### BACKGROUND ART

In recent years, high accuracy of target position detection has been increasing in importance for automatic driving of a vehicle. A millimeter-wave radar device used in automatic driving is generally installed in a bumper in many cases, and may deviate from a mounting angle of the millimeter-wave radar device originally aimed at due to a mounting error generated when the bumper is mounting, vibration or impact after mounting.

In a case where a vehicle that travels in the host vehicle lane is erroneously detected as an adjacent lane, for example, when the front vehicle is detected, by deviation of the mounting angle of the millimeter-wave radar, activation of an alarm or automatic braking may be delayed. In addition, in a case where there is a mounting angle deviation when position information is combined with another sensor such as a camera, there is a possibility that the same target is not successfully combined and it is determined that the target is another target, or the target is overlooked. Even in a case where the mounting angle deviation is relatively small, it is necessary to widen a gate range for capturing a target in consideration of the mounting angle deviation when tracking the target is performed. When the gate range is widened, the frequency of picking up noise such as clutter increases. Thus, the probability of performing erroneous tracking increases, and as a result, the possibility of overlooking the target increases.

As a technique for correcting a mounting angle of a millimeter-wave radar of a vehicle, for example, PTL 1 is known. In PTL 1, an axle is calculated by sensing the entire vehicle with a vehicle surrounding recognition sensor, and a deviation amount of a mounting angle of the sensor is calculated from a relationship between a target installed in front of the vehicle, the calculated axle, and an angle azimuth of the target detected by the sensor. It is possible to calculate an accurate axle, but a dedicated system is required. Thus, it is necessary to bring a vehicle to a dedicated facility in which the system is deployed for a vehicle after shipment.

In PTL 2, a target having a relative speed of 0 is detected under a condition that the host vehicle is traveling straight, and a deviation amount of a mounting angle is calculated by using the point that the target having a relative speed of 0 has 90 degrees with respect to a traveling direction. In this method, it is not necessary to bring a vehicle into a dedicated facility, but it is necessary to accumulate targets having a relative speed of zero. In particular, in a front radar installed in front of a vehicle, a target in an angle azimuth directly beside (90 degrees with respect to a traveling direction) is hardly detected, and thus it is necessary to travel for a long time in a state where an angle deviation is not detected even in a case where a mounting angle is deviated.

### CITATION LIST

### Patent Literatures

PTL 1: JP 2019-74398 A
PTL 2: JP 2014-153256 A

### SUMMARY OF INVENTION

### Technical Problem

An object of the present invention is to realize a radar device that automatically detects and automatically corrects a deviation in a short time when the deviation has occurred in a mounting angle in the radar device.

The foregoing and other objects and novel features of the present invention will become apparent from the description of the present specification and the accompanying drawings.

### Solution to Problem

Representative aspects of the invention disclosed in the present application will be briefly described as follows.

A lateral wall parallel to a traveling direction is extracted through a function fitting process by a function fitting processing unit (112) from a distance and a relative speed which are a result of performing positioning of a radar device. Then, a calculation processing unit (114) calculates an angle azimuth β of each point extracted as the lateral wall based on a host vehicle speed calculated at the time of the function fitting and the distance to the lateral wall. A comparison processing unit (115) compares the calculated angle azimuth β with an angle azimuth Θ that is a positioning result to detect a mounting angle deviation in the radar device, and a correction processing unit (116) corrects the mounting angle deviation.

### Advantageous Effects of Invention

It is possible to automatically detect a radar mounting angle to a vehicle in a short time with high accuracy. In addition, it is possible to detect a host vehicle speed with high accuracy simultaneously with the mounting angle.

Objects, configurations, and advantageous effects other than those described above will be clarified by the descriptions of the following forms for embodying the present invention.

### BRIEF DESCRIPTION OF DRAWINGS

FIG. 1 is a diagram for describing a block configuration of a radar device according to an embodiment of the present invention.

FIG. 2 is an image diagram illustrating a relationship between a lateral wall parallel to a host vehicle speed vector and a relative speed.

FIG. 3 is an image diagram of a curve obtained by showing the lateral wall parallel to the host vehicle speed vector in a two-dimensional plane of a distance R and a relative speed V, and is a formula of the curve.

FIG. 4 is a diagram illustrating a result of a point group detected as a target and a result of extracted curve fitting in the two-dimensional plane of the distance R and the relative speed V.

FIG. 5 illustrates a result of displaying a point group extracted as the lateral wall with a horizontal axis as an angle azimuth Θ and a vertical axis as an angle azimuth β, and a result of linear approximation.

FIG. 6 illustrates an example of a data configuration output to a memory.

FIG. 7A is an image diagram of a curve in a two-dimensional plane of a distance R and a relative speed V in a case where there is a lateral wall curved convexly with respect to the vehicle.

FIG. 7B is an image diagram of a curve in a two-dimensional plane of a distance R and a relative speed V in a case where there is a lateral wall curved concavely with respect to the vehicle.

FIG. 8A is an image diagram of a curve in a two-dimensional plane of a distance R and a relative speed V in a case where there is a lateral wall inclined in a direction approaching a host vehicle speed Vr vector.

FIG. 8B is an image diagram of a curve in a two-dimensional plane of a distance R and a relative speed V in a case where there is a lateral wall inclined in a direction far away from the host vehicle speed Vr vector.

FIG. 9 is a diagram for describing another block configuration of the radar device according to the embodiment of the present invention.

### DESCRIPTION OF EMBODIMENTS

Hereinafter, an embodiment of the present invention will be described with reference to the drawings. The embodiment and examples are for describing the present invention, and are omitted and simplified as appropriate for clarity of description. The present invention can be implemented in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the positions, sizes, shapes, ranges, and the like illustrated in the drawings.

In a case where there is a plurality of components having the same or similar functions, the same reference signs may be denoted with different subscripts for description. In addition, in a case where it is not necessary to distinguish the plurality of components, the description may be made by omitting the subscript.

### Embodiment 1

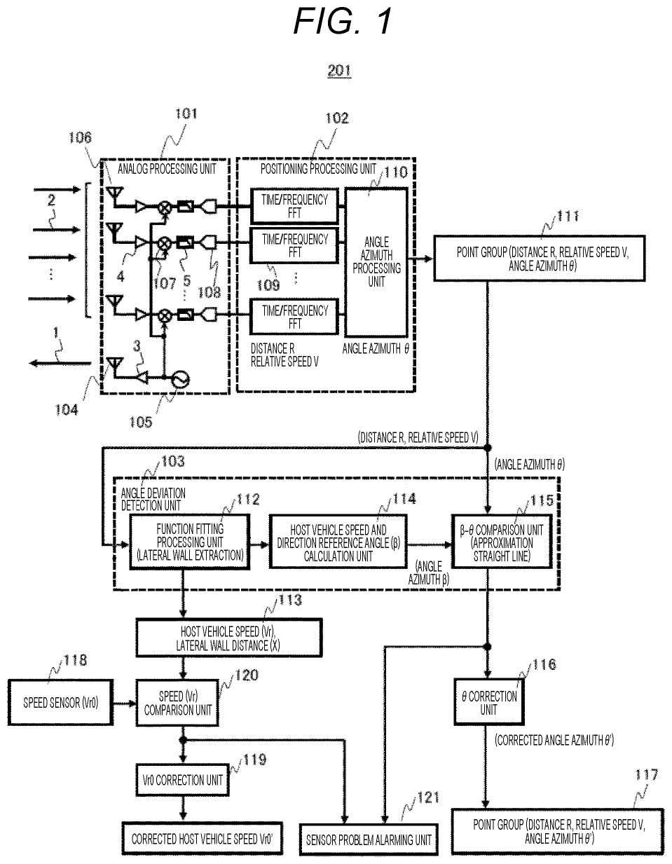

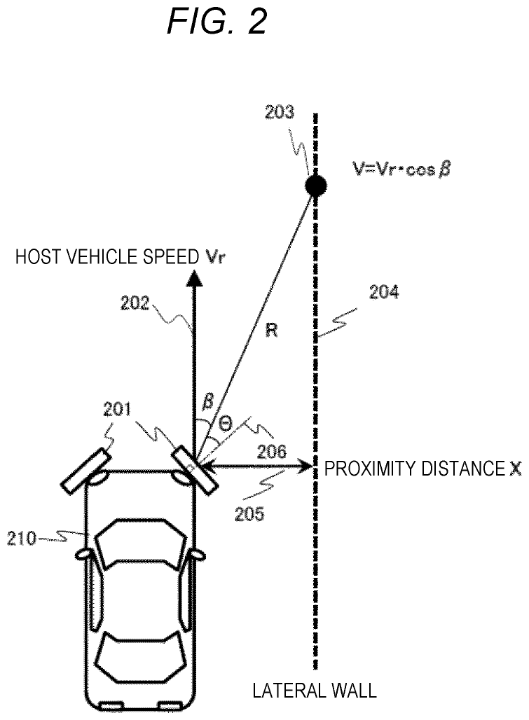

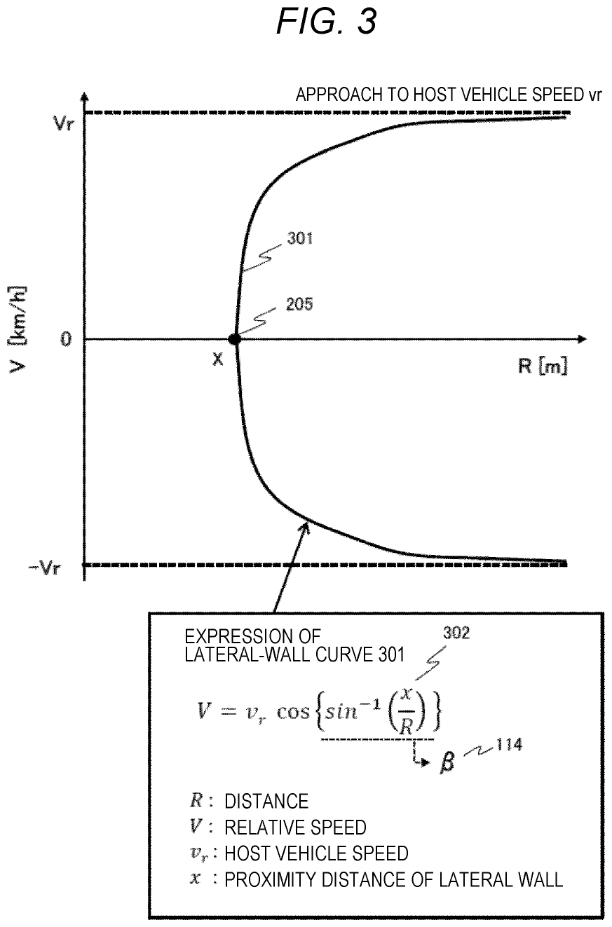

A representative embodiment of the invention disclosed in the present application will be described with reference to the drawings. FIG. 1 is a diagram for describing a block configuration of a radar device according to the embodiment. FIG. 2 is an image diagram illustrating a relationship between a lateral wall parallel to a host vehicle speed vector and a relative speed. FIG. 3 is an image diagram of a curve obtained by showing the lateral wall parallel to the host vehicle speed vector in a two-dimensional plane of a distance R and a relative speed V, and is a formula of the curve.

A radar device (201) according to a representative embodiment of the present invention is an in-vehicle millimeter-wave radar device mounted on right and left front corners of an automobile. The radar device (201) includes an analog processing unit (101), a positioning processing unit (102), and an angle deviation detection unit (103) as illustrated in FIG. 1.

The analog processing unit (101) outputs a millimeter wave radar as a transmission signal 1 from a transmission antenna (104). Here, as the transmission signal 1, a chirp signal in which an output signal of a synthesizer (105) is used and a frequency is linearly transitioned with time is often used. The output signal output from the synthesizer (105) is amplified by a transmission amplifier 3 and then transmitted from the transmission antenna (104).

The transmitted transmission signal 1 is reflected by a target, and a portion of the reflection wave is brought back to a reception array antenna (106) and then received as a reception signal 2. The reception array antenna (106) includes a plurality of reception antennas that receives reflected waves of a millimeter wave radar. The reception signals 2 received by the plurality of reception antennas of the reception array antenna (106) are amplified by a plurality of reception amplifiers 4, input to a plurality of mixers (107) as frequency converters, and then down-converted by the plurality of mixers (107), respectively. At this time, the output signal of the synthesizer (105) is used as a local signal of the mixers (107). As a result, a time difference between the transmission signal and the reception signal, that is, a frequency corresponding to a distance of a target, which is a target, is output as a plurality of analog output signals from the plurality of mixers (107). After being subjected to filter processing by a plurality of filters 5, the plurality of analog output signals of the mixers (107) is input to a plurality of A/D converters (analog-to-digital conversion circuits) (108), converted into a plurality of digital signals, and then transmitted to the positioning processing unit (102) as a plurality of digital output signals, respectively. Here, the target includes a moving object such as an automobile or a person, an object stationary on the ground such as a wall or a utility pole, and the like.

The positioning processing unit (102) receives the plurality of digital output signals from the analog processing unit (101) as reception signals, and performs fast Fourier transform (FFT) processing on each reception signal by a plurality of time/frequency FFT processing circuits (109). The FFT processing includes frequency FFT and time FFT. It is possible to grasp a distance R and a relative speed V by performing frequency FFT and time FFT, respectively. If the distance R and the relative speed V to be targeted are determined, a complex signal of each reception signal can be extracted from the result of the FFT processing, and an angle azimuth processing unit (110) calculates an angle azimuth Θ (first angle azimuth) of the target by using angle azimuth processing such as spatial FFT processing, digital beam forming processing, or multiple signal classification (MUSIC) processing from the regularity of the complex signal of each reception signal. As an output of the positioning processing unit (102), a point group (111) having information of the distance R, the relative speed V, and the angle azimuth Θ corresponding to the number of targets is output.

Here, the relative speed V calculated by a time/frequency FFT processing circuit (109) is a change amount per unit time of a concentric distance around the millimeter-wave radar device (201). As illustrated in FIG. 2, the relative speed V of a stationary target (203) in an angle β direction (second angle azimuth) with respect to a traveling direction of a vehicle 210 traveling in a direction of a host vehicle speed Vr vector (202) has a value obtained by multiplying a host vehicle speed Vr by a term of a cosine β (V=Vr·cos β). In the vehicle 210 illustrated in FIG. 2, an example in which the millimeter-wave radar device (201) is also provided at the left front corner is illustrated.

In addition, a lateral wall (204), which is a feature parallel to the host vehicle speed Vr vector (202) illustrated in FIG. 2, draws a specific curve (301) as illustrated in FIG. 3 in a two-dimensional plane of the distance R and the relative speed V. The curve (301) is a curve that passes through a proximity distance X (205) when the relative speed V becomes 0. The curve (301) is a curve that asymptotically approaches the host vehicle speed Vr when the distance R increases, and is a curve uniquely determined by the host vehicle speed Vr and the proximity distance X as represented by the formula (302) of the curve (301) of the lateral wall (204). Here, the feature is an object stationary on the ground, such as a wall or a utility pole.

An angle deviation detection unit (103) extracts the lateral wall (204) parallel to the host vehicle speed Vr vector (202) by performing a function fitting process by a function fitting processing unit (112) from point group information of the distance R and the relative speed V among the distance R, the relative speed V, and the angle azimuth Θ of the point group (111). Specifically, in the function fitting process, a process of sweeping the host vehicle speed Vr and the proximity distance X to determine the curve (301) in FIG. 3 that fits the point group most is performed. In fitting, a point away from the curve (301) is not regarded as the lateral wall (204), and detection is performed as the lateral wall (204) in a case where the number of points corresponding to fitting is more than a predetermined threshold value. In a case where the lateral wall (204) is detected, the host vehicle speed Vr and the lateral wall distance X are calculated as information (113). Pieces of information (113) can be utilized for a correction unit (119) of the host vehicle speed Vr0 output from a vehicle speed sensor (118) and as automatic driving information. In a case where a comparison result obtained in a manner that a comparison unit (120) compares the host vehicle speed Vr obtained by the function fitting processing unit (112) with the host vehicle speed Vr0 obtained by the vehicle speed sensor (118) is greater than a predetermined error, it is possible to notify a driver of the vehicle 210 or the like of the failure or accuracy deterioration of the vehicle speed sensor (118) as a sound or a display by generating an alarm from a sensor problem alarm unit (121) as a sensor problem. Further, it is also possible to utilize an error between the point group subjected to the function fitting process by the function fitting processing unit (112) and the function as accuracy information of the detection accuracy of the lateral wall (204). The comparison unit (120) and the correction unit (119) can be collectively referred to as a correction function of the host vehicle speed Vr0 by the vehicle speed sensor (118).

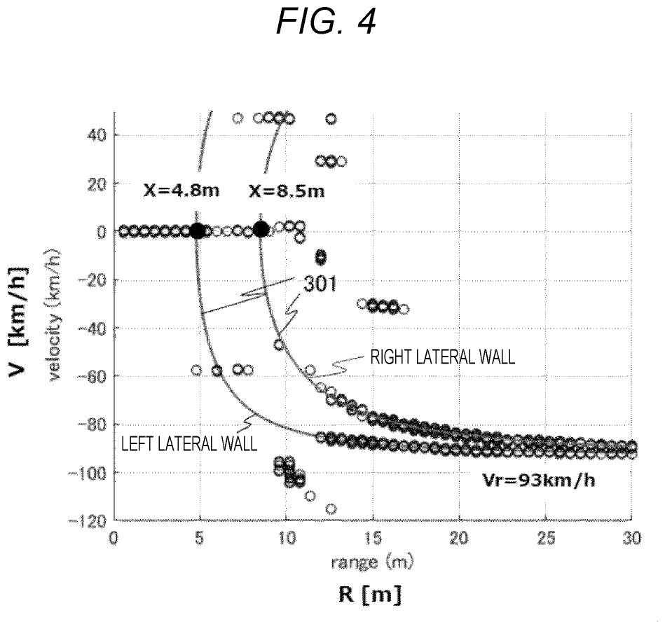

FIG. 4 illustrates a point group (111) of the detected target and a curve (301) extracted by the function fitting processing unit (112). It is understood that the host vehicle speed of 93 km/h, a right lateral wall at a distance of 8.5 m, and a left lateral wall at a distance of 4.8 m are detected by the function fitting processing unit (112).

When the host vehicle speed Vr or the lateral wall distance X is known by calculation of the function fitting processing unit (112), the angle azimuth β of each point of the point group can be obtained by the angle azimuth β calculation unit (114) using a formula of the curve (302). As a result, each point of the point group extracted as the lateral wall (204) can have two types of angle azimuth information of the angle azimuth β calculated by the angle azimuth β calculation processing unit (114) and the angle azimuth Θ calculated in advance by the angle azimuth processing unit (110). Since the angle azimuth β is based on the host vehicle speed Vr vector (202), and the angle azimuth Θ is based on a mounting direction of the millimeter-wave radar device (201), that is, a mounting axis 206, an angle comparison processing unit (115) can compare the two angles (β, Θ) and calculate the mounting angle of the millimeter-wave radar device (201). The mounting angle of the millimeter-wave radar device (201) means an angle between the host vehicle speed Vr vector (an axle direction or the front-rear direction of the vehicle) and the mounting axis 206. In comparing the two angles (β, Θ), as an example, a point group may be formed on a two-dimensional plane of the angle azimuth Θ and the angle azimuth β, and linear approximation may be performed on the point group.

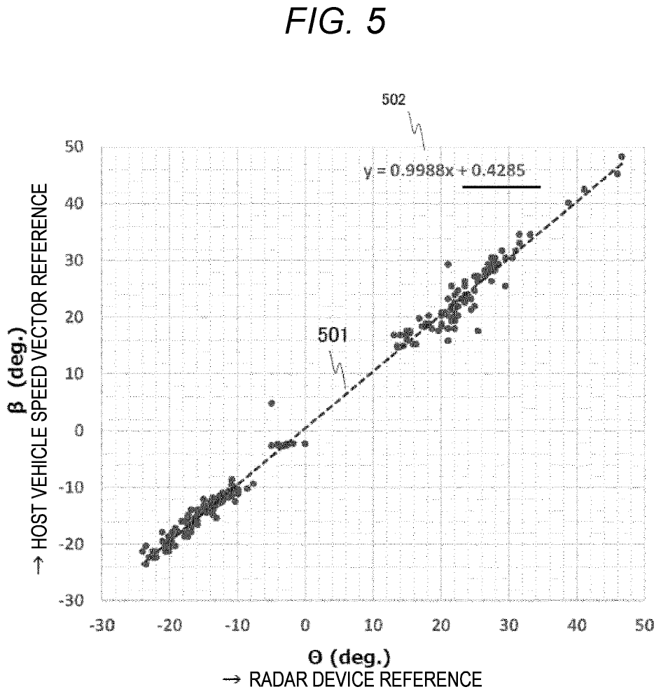

FIG. 5 illustrates a result of displaying the point group extracted as the lateral wall with the horizontal axis as the angle azimuth Θ and the vertical axis as the angle azimuth β, and a result of linear approximation. A dotted line (501) in FIG. 5 is a straight line indicating linear approximation of the point group. It can be understood that the inclination of the straight line is 1 when it is considered that Θ and B are angle azimuths of the same scale. In a case where the inclination greatly deviates from 1, it can be determined that there is a problem as data, and thus it is possible to perform handling such as discarding the data. Since the inclination (0.9988) of a linear approximation formula (502: y=0.9988x+0.4285) in FIG. 5 is close to 1, it can be determined that the linear approximation formula is normal as data. 0.4285 that is the y intercept of the linear approximation formula (502) represents the angle deviation between the angle azimuth β and the angle azimuth Θ, and the value of the y intercept indicates the mounting angle deviation in the millimeter-wave radar device (201). By statistically accumulating the values of the y-intercept, it is possible to calculate an accurate mounting angle deviation of the millimeter-wave radar device (201).

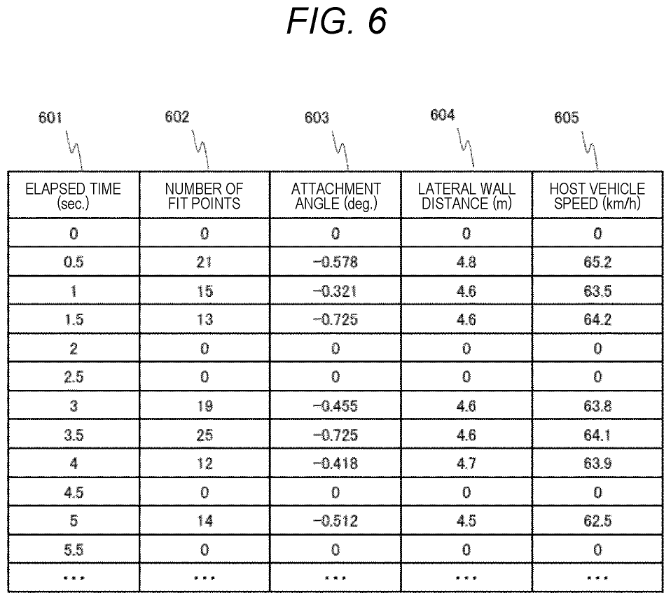

FIG. 6 illustrates an example of a data configuration output to the memory, and illustrates an example of a data configuration when data is statistically accumulated. An elapsed time (601) represents the elapsed time after the correction of the angle deviation or the issuing of the alarm is performed. In a case where the linear approximation formula (502) is calculated at intervals of 0.5 seconds, data is accumulated in units of 0.5 seconds. A number of fit points (602) indicates the number of points in the point group extracted when the function fitting processing unit (112) performs the function fitting on the curve (301). Since the detection accuracy of the angle deviation is improved as more number of points are used, it is possible to improve the use accuracy of data by using the number of points (602) as weighting. A mounting angle (603) is a numerical value (mounting angle deviation) corresponding to the y-intercept of the linear approximation formula (502). A lateral wall distance (604) and a host vehicle speed (605) are values calculated by the function fitting processing unit (112), and correspond to the information (113) of the host vehicle speed Vr and the lateral wall distance X in FIG. 1.

An example of calculating the mounting angle deviation includes a method of calculating the mounting angle deviation by averaging weights by the number of points (602) fitted to the mounting angle (603). Here, in a case where the cumulative value of the fitted number of points (602) exceeds a predetermined threshold value, by providing a mechanism of calculating the weight average value described above, it is possible to detect the mounting angle deviation value with desired error accuracy.

Regarding the detected mounting angle deviation, a simple correction process of subtracting the angle deviation (603) from the angle azimuth Θ calculated by the angle azimuth processing unit (110) is performed by the correction processing unit (116), so that it is possible to calculate a corrected angle azimuth Θ′ without an error in the mounting angle and output a corrected positioning result (117) related to the point group. In addition, in a case where the detected mounting angle deviation value (603) exceeds a predetermined threshold value, by providing a mechanism of issuing an alarm as a problem of the sensor (sensor problem alarm unit 121 in FIG. 1), it is also possible to use a method of guaranteeing the beam width in the antenna design and the viewing angle as the system design.

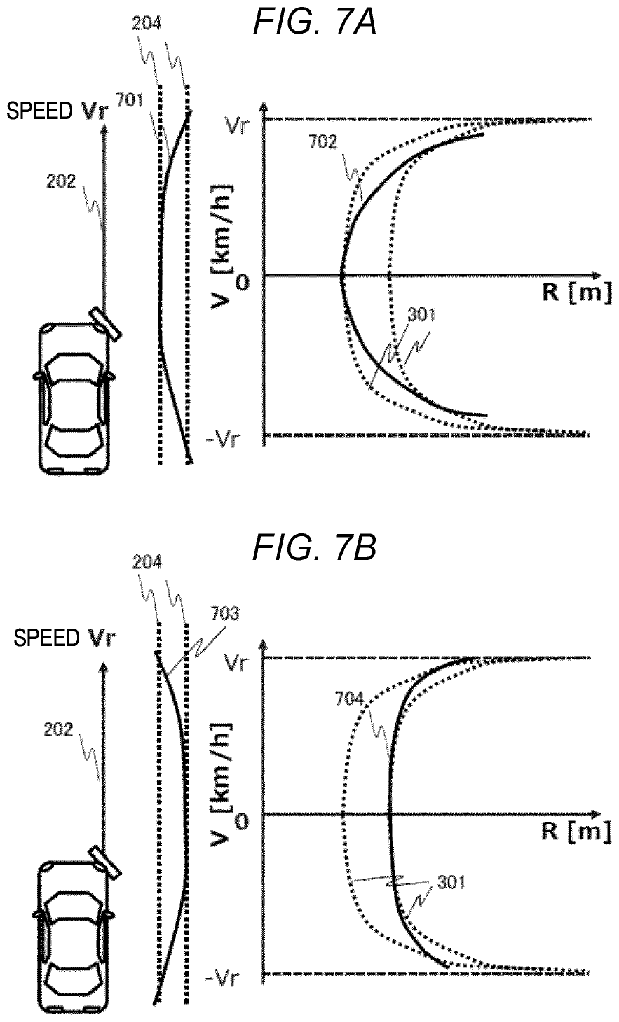

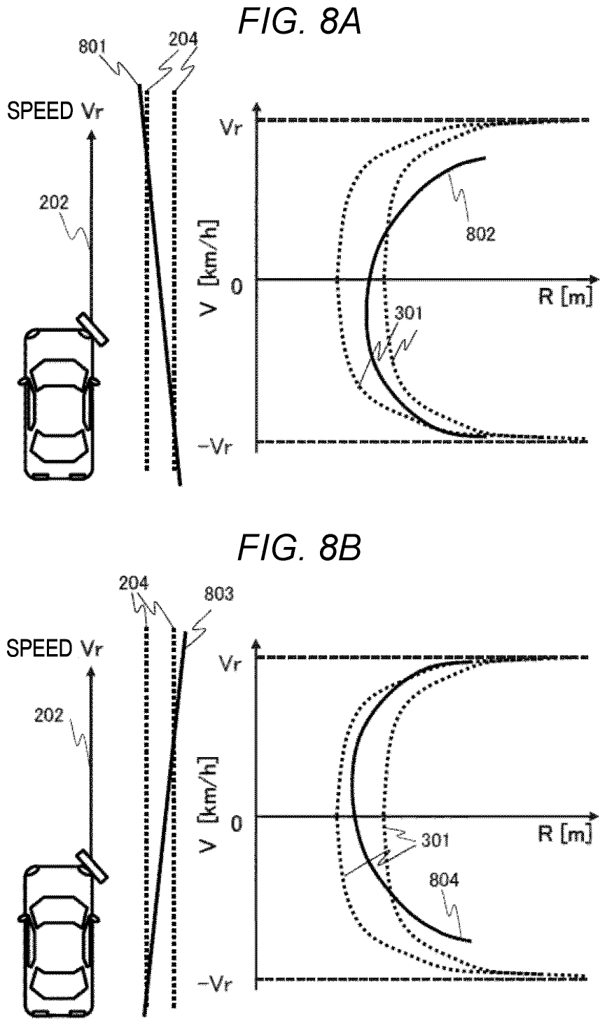

Here, as a concern, it is expected that an error in the angle azimuth β calculated in a case where the detected lateral wall is greatly curved or in an inclined direction increases. FIGS. 7A, 7B, 8A, and 8B are diagrams illustrating deviation from the curve (301) extracted by the function fitting processing unit (112) in these cases.

FIG. 7A illustrates a curve (702) of a lateral wall (701) that curves convexly with respect to the vehicle, in a two-dimensional plane of the distance R and the relative speed V. FIG. 7B illustrates a curve (704) of a lateral wall (703) that curves concavely with respect to the vehicle, in a two-dimensional plane of the distance R and the relative speed V. Since the curves (702) and (704) are curves different from the curve (301) in the two-dimensional plane of the lateral wall (204) parallel to the host vehicle speed Vr vector (202), there is a high possibility of omitting the curves in the function fitting processing by the function fitting processing unit (112). That is, since the curve is not detected as the lateral wall (204), the curve does not have an influence as the error of the angle azimuth β.

FIGS. 8A and 8B illustrate a case where there is a lateral wall inclined with respect to the host vehicle speed Vr vector (202). FIG. 8A illustrates a curve (802) in a two-dimensional plane of the distance R and the relative speed V in a case where there is a lateral wall (801) inclined in a direction approaching the host vehicle. FIG. 8B illustrates a curve (804) in a two-dimensional plane of the distance R and the relative speed V in a case where there is a lateral wall (803) inclined in a direction away. The curves (802) and (804) are characterized by asymmetrical curves on a positive side and a negative side of the relative speed V. Since the curves are different from the curve (301) in the two-dimensional plane of the lateral wall (204) parallel to the host vehicle speed Vr vector (202) indicated by the dotted line, there is a high possibility of omitting the curves in the function fitting processing by the function fitting processing unit (112), as in the case of the curved lateral walls (701) and (703).

However, there is a possibility that the lateral wall having a gentle curve or the lateral wall having a gentle inclination is detected as a lateral wall parallel to the traveling direction because the lateral wall has a certain degree of coincidence with the curve (301) extracted by the function fitting processing unit (112). At this time, by performing weighted cumulative averaging using the error between the point group subjected to function fitting by the function fitting processing unit (112) and the curve (301) of the function as the accuracy information of the detection accuracy of the lateral wall, it is possible to suppress deterioration of the detection accuracy of the mounting angle deviation. As another method, if the detection of the lateral wall is not performed in a case where the steering angle sensor exceeds a predetermined steering angle range, it is possible to more completely omit the detection of the curve or the inclined lateral wall, and thus, it is possible to improve the detection accuracy of the mounting angle deviation. For example, the lateral wall extraction may be performed only in a steering angle range within a steering angle of +/−5 degrees. In this case, the lateral wall extraction is not performed in the steering angle range other than the steering angle +/−5 degrees.

As another concern about accuracy deterioration of the mounting angle deviation, in a case where the relative speed V is faster than a predetermined speed, the relative speed V slower than the actual speed caused by the FFT folding at the time of calculation of the time/frequency FFT processing circuit (109) is output. Therefore, there is a possibility of failure in the function fitting processing by the function fitting processing unit (112), which causes deterioration of the detection accuracy of the mounting angle deviation. Regarding the turning back of the relative speed, it is possible to suppress the deterioration of the detection accuracy of the mounting angle deviation in a manner that the two-dimensional planes of the distance R and the relative speed V are repeatedly arranged, and then the function fitting process is performed by the function fitting processing unit (112). Furthermore, if the lateral wall is extracted only at a predetermined traveling speed by using the speed sensor, it is possible to further suppress the deterioration of detection accuracy of the mounting angle deviation. For example, if the turning speed of the relative speed is 70 km/h, the lateral wall may be extracted while the detection speed by the speed detection output of the speed sensor is limited to a predetermined speed range such as 5 km/h to 70 km/h. In this case, the lateral wall is not extracted in a range other than the range of 5 km/h to 70 km/h. That is, the predetermined steering angle range or the predetermined speed range can be used as an activation condition of the angle deviation detection unit (103) or the function fitting processing unit (112).

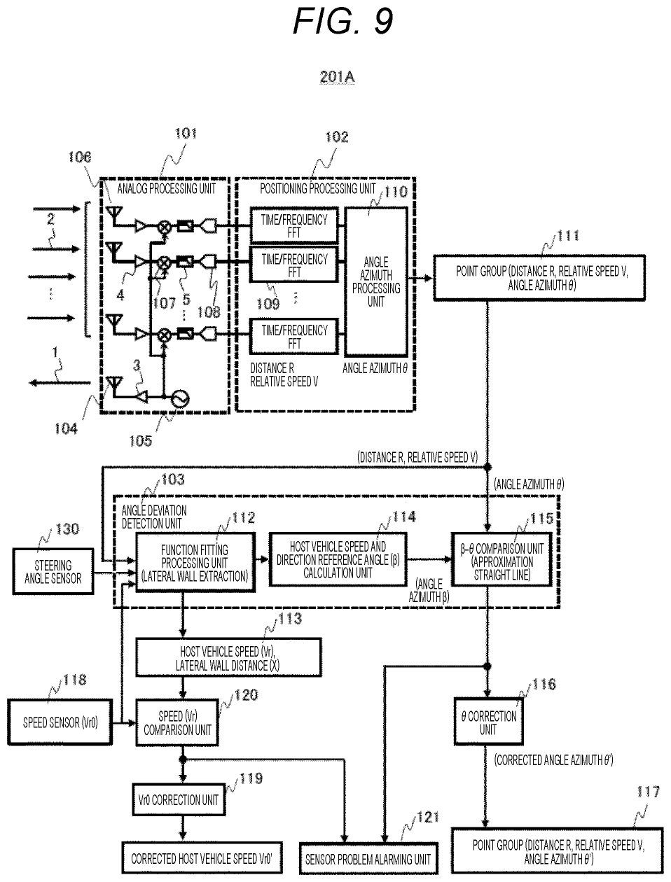

FIG. 9 is a diagram for describing another block configuration of the radar device according to the embodiment of the present invention. FIG. 9 is different from FIG. 1 in that, in a radar device 201A of FIG. 9, the steering angle detection output of the steering angle sensor 130 and the speed detection by the speed detection output of the speed sensor are input to the function fitting processing unit (112) in the angle deviation detection unit 103. The other configuration and operation of the radar device 201A are the same as those of the radar device 201 of FIG. 1, and the repetitive description thereof will be omitted.

As a result, as described above, the operation of the function fitting processing unit (112) is controlled to extract the lateral wall in a predetermined steering angle range in which the steering angle detection output of the steering angle sensor 130 is within the steering angle +/−5 degrees, and to extract the lateral wall in a predetermined speed range in which the detection speed by the speed detection output of the speed sensor is from 5 km/h to 70 km/h. The function fitting processing unit (112) may be controlled to perform the operation of the lateral wall extraction so that the lateral wall is extracted with limitation within the steering angle range of +/−5 degrees and the speed range of 5 km/h to 70 km/h.

The predetermined steering angle range or the predetermined speed range can be used as the activation condition of the angle deviation detection unit (103) or the function fitting processing unit (112). As a result, when a deviation has occurred in the mounting angle in the radar device, it is possible to automatically detect and automatically correct the deviation in a short time. In addition, it is possible to improve the detection accuracy of the mounting angle deviation. Further, it is possible to suppress deterioration of detection accuracy of the mounting angle deviation.

In FIGS. 1 and 9, the positioning processing unit 102, the angle deviation detection unit 103, the correction processing unit 116 for the angle azimuth Θ, the correction unit 119 for the host vehicle speed Vr0, the host vehicle speed comparison unit 120, the sensor problem alarm unit 121, and the like may be each configured by a dedicated hardware circuit or may be configured by software. In the case of being configured by software, a system is configured by using a microcomputer or a microprocessor including a central processing unit CPU, a read-only memory ROM, a random access memory RAM, and the like, the software stored in the ROM is executed by the CPU, and an execution result and the like are stored in the RAM. Thus, it is possible to automatically detect the radar mounting angle to the vehicle in a short time with high accuracy.

Hitherto, although the invention made by the present inventors has been specifically described above based on the embodiment, the present invention is not limited to the above embodiment, and it goes without saying that various modifications can be made.

### REFERENCE SIGNS LIST

101 analog processing unit
102 positioning processing unit
103 angle deviation detection unit
104 transmission antenna
105 synthesizer
106 reception array antenna
107 mixer
108 A/D converter
109 time/frequency FFT processing circuit
110 angle azimuth processing unit
111 point group of detected target
112 function fitting processing unit
113 distance (X) to lateral wall
114 angle azimuth (β) calculation processing unit
115 angle azimuth comparison unit
116 correction processing unit of angle azimuth (Θ)
117 positioning result without error in mounting angle
118 speed sensor
119 speed sensor detection speed correction unit
120 host vehicle speed comparison unit
121 sensor problem alarm unit
130 steering angle sensor
201 millimeter-wave radar device
202 host vehicle speed vector (Vr)
203 stationary target in angle β direction
204 lateral wall parallel to host vehicle speed vector
205 proximity distance (X)
206 mounting axis
301 curve of lateral wall parallel to host vehicle speed vector in plane of distance-relative speed
302 formula of curve of lateral wall parallel to host vehicle speed vector
501 straight line indicating linear approximation
502 linear approximation formula
601 elapsed time
602 number of fit points (detection result)
603 mounting angle (detection result)
604 lateral wall distance (detection result)
605 host vehicle speed (detection result)
701 curved lateral wall
702 curve of curved lateral wall in plane of distance-relative speed
703 curved lateral wall
704 curve of curved lateral wall in plane of distance-relative speed
801 inclined lateral wall
802 curve of inclined lateral wall in plane of distance-relative speed
803 inclined lateral wall
804 curve of inclined lateral wall in plane of distance-relative speed

1. An in-vehicle radar device capable of measuring a first angle azimuth of a target, a distance to the target, and a relative speed by a plurality of reception antennas, the radar device comprising:
a function fitting processing unit that extracts a feature including a lateral wall parallel to a traveling direction of a vehicle from information of the distance and the relative speed by function fitting;
a processing unit that calculates a second angle azimuth of the feature from a result of the function fitting; and
a processing unit that calculates an angle deviation of a mounting axis of the radar device by comparing the first angular azimuth and the second angular azimuth.

2. The radar device according to claim 1, further comprising a processing unit that corrects the angle deviation of the mounting axis from a calculation result of the angle deviation.

3. The radar device according to claim 1, wherein a function of issuing an alarm in a case where the angle deviation exceeds a predetermined angle deviation from a calculation result of the angle deviation is provided.

4. The radar device according to claim 1, wherein the function fitting processing unit is configured to calculate a host vehicle speed from information of the distance to the feature and the relative speed at the time of the function fitting.

5. The radar device according to claim 4, wherein a correction function of correcting an error of a speed sensor from a result of the host vehicle speed is provided.

6. The radar device according to claim 5, wherein the function fitting processing unit performs the function fitting in a predetermined speed range of a speed detection output from the speed sensor.

7. The radar device according to claim 5, wherein the function fitting processing unit performs the function fitting in a predetermined steering angle range of a steering angle detection output from a steering angle sensor.

8. The radar device according to claim 7, wherein the function fitting processing unit performs the function fitting when the steering angle detection output is in the predetermined steering angle range and a speed detection output from the speed sensor is in a predetermined speed range.

9. A radar device mounted on a vehicle, wherein
the radar device is configured to:
extract a lateral wall parallel to a traveling direction of the vehicle through function fitting from a distance and a relative speed of the vehicle that are a result of performing positioning the radar device;
calculate an angle azimuth β of each point extracted as the lateral wall based on a host vehicle speed of the vehicle calculated at the time of the function fitting and a distance to the lateral wall; and
compare the calculated angle azimuth β with an angle azimuth Θ that is the positioning result to detect a mounting angle deviation in the radar device and correct the mounting angle deviation.
